(19) United States
(12) Patent Application Publication
(10) Pub. No.: US 2006/0155790 A1
(43) Pub. Date: Jul. 13, 2006

(54) Manifest file structure, method of downloading contents usng the same, and apparatus for reproducing the contents

(75) Inventors: Kil-soo Jung, Hwaseong-si (KR); Kwang-min Kim, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/322,354

(22) Filed: Jan. 3, 2006

Related U.S. Application Data
(60) Provisional application No. 60/642,550, filed on Jan. 11, 2005.

(30) Foreign Application Priority Data
Mar. 17, 2005 (KR) 2005-22186

(51) Int. Cl. G06F 12/00; G06F 17/30

(52) U.S. Cl. 707/205

(57) ABSTRACT

A structure of a manifest file containing information on contents stored in a local storage device of a reproducing apparatus, a method of downloading the contents using the structure of the manifest file, and an apparatus for reproducing the contents. The structure of the manifest file includes contents information and 0version information of the manifest file and description information on at least one predetermined unit forming the contents.

### CROSS-REFERENCE TO RELATED APPLICATIONS

This application claims the benefit of U.S. Provisional Patent Application No. 60/642,550, filed Jan. 11, 2005 and Korean Application No. 10-2005-22186, filed Mar. 17, 2005, in the Korean Intellectual Property Office, the disclosures of which are incorporated herein by reference.

### BACKGROUND OF THE INVENTION

1. Field of the Invention

An aspect of the present invention relates to a manifest file, and, more particularly, to a structure of a manifest file containing information on contents stored in a local storage device of a reproducing apparatus, a method of downloading the contents using the structure of the manifest file, and an apparatus to reproduce the contents.

2. Description of the Related Art

An apparatus to load a recording medium such as a digital versatile disc (DVD), a blu-ray disc (BD), etc., which stores video contents and to reproduce the loaded recording medium includes a local storage device in addition to a unit to receive the recording medium. The local storage device is connected to a server that stores contents via a network, downloads the contents, and stores the downloaded contents. Therefore, the reproducing apparatus combines the video contents recorded in a recording medium inserted therein with the contents stored in the local storage device and generates new contents.

However, to remove the contents stored in the local storage device or to download additional contents at the request of a user, a manifest file which contains information on what contents are stored in the local storage device of a reproducing apparatus is required.

### SUMMARY OF THE INVENTION

An aspect of the present invention provides a structure of a manifest file containing information on what contents are stored in local storage device of a reproducing apparatus, a method of downloading the contents using the structure of the manifest file, and an apparatus to reproduce the contents.

According to an aspect of the present invention, there is provided a structure of a manifest file including contents information, wherein the manifest file comprises version information of the manifest file and description information on at least one predetermined unit forming the contents.

The manifest file comprises: a studio ID that represents information on producers that produce the contents; a disc ID identifying information recording media storing the contents; version information of the manifest file; and at least a piece of contents information that provides description information in a predetermined unit that divides the contents recorded on the information recording media.

The version information comprises: a version value of a current manifest file; and a table regarding the predetermined unit relating to a deletion of contents.

According to another aspect of the present invention, there is provided a method of downloading contents from an apparatus to reproduce the contents using a local storage device, the method comprising: receiving a contents download list prepared based on version information of a manifest file including information on contents stored in the local storage; and selecting contents to be downloaded in the received download list, if the size of the local memory is determined to be enough to download the selected contents, downloading the selected contents, and deleting a part of contents in the local storage device and downloading the selected contents if the size of the local memory is determined to not be enough to download the selected contents.

According to still another aspect of the present invention, there is provided an apparatus to reproduce contents obtained by combining contents stored in a local storage device and contents read from a recording medium, the apparatus comprising: the local storage device storing contents downloaded via a network; and an application manager to receive a contents download list prepared based on version information of a manifest file including information on contents stored in the local storage device, to select contents to be downloaded in the received download list, to download the selected contents if the size of the local memory is determined to be enough to download the selected contents, and to delete a part of contents in the local storage device and to download the selected contents if the size of the local memory is determined to not be enough to download the selected contents.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates types of data recorded in an information recording medium according to an embodiment of the present invention;

FIG. 2 illustrates a structure of multimedia data recorded on the information recording medium illustrated in FIG. 1;

FIG. 3 is a block diagram of the constitution of a clip AV stream illustrated in FIG. 2;

FIG. 4 illustrates a directory structure of the information recording medium on which the data illustrated in FIG. 1 are recorded;

FIG. 5 illustrates the forming of a virtual file system according to an embodiment of the present invention;

FIG. 6 is a block diagram of a reproducing apparatus according to an embodiment of the present invention;

FIG. 7 illustrates a structure of a manifest file according to an embodiment of the present invention;

FIG. 8 illustrates a constitution of version information included in the manifest file illustrated in FIG. 7;

FIG. 9 illustrates a constitution of contents information included in the manifest file illustrated in FIG. 7;

FIG. 10 is a flowchart of a method of downloading contents according to an embodiment of the present invention;

FIG. 11 illustrates an example of information on a relationship between contents recorded on database included in a studio server and a manifest file according to an embodiment of the present invention;

FIG. 12 illustrates an example of a screen for downloading contents according to an embodiment of the present invention;

FIG. 13 is a flowchart of a clean up process according to an embodiment of the present invention; and

FIG. 14 illustrates an example of a screen for deleting contents according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

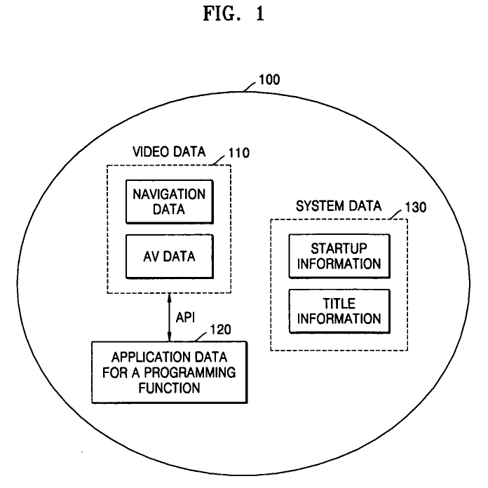

FIG. 1 illustrates types of data recorded on an information recording medium according to an embodiment of the present invention. Referring to FIG. 1, the information recording medium 100, according to an embodiment of the present invention, includes video data 110, application data for a programming operation (hereinafter referred to as “application data”) 120, and system data 130.

The video data 110, which are reproducing mode data to reproduce video, are called core mode data or movie mode data. The video data 110 includes compression-coded AV data and navigation data to control the reproduction of the AV data. Therefore, the AV data may be reproduced based on the navigation data of the information recording medium 100, so that a user may watch video such as a high quality movie.

The application data 120 which are programming data to interact with the user are called full mode data or program mode data. The application data 120 may provide a variety of applications, such as a video game function, a function to display a director's commentary while some parts of video are being reproduced, a function to display other additional information while some parts of video are being reproduced, and a function to chat while some parts of video are being reproduced, and the like. The application data 120 also may reproduce a movie using information on recent news regarding movie actors stored in web pages or other databases relating to movies recorded on the information recording medium 100, event news relating to movies or updated subtitles, and the like.

The application data 120 may include an application program interface (API) function regarding a presentation engine that reproduces video information to be described later in order to execute an application program along with video. The application data 120 are written in programming languages such as C or JAVA.

The system data 130 includes startup information and title information. The startup information contains information on position of data to be first reproduced when the information recording medium 100 are reproduced by a reproducing apparatus. The title information contains information on entries and attributes of data to be operated when each of the titles is being reproduced.

As is described above, the information recording medium 100 according to an embodiment of the present invention includes the video data 110 and the application data 120 for the programming operation so as to provide various interactive operations for users in addition to the video reproduction. In particular, the information recording medium 100 downloads new contents from an external database and reproduces the downloaded contents, and furthermore, manages the downloaded contents to reproduce the downloaded contents during a next time the recording medium is operated.

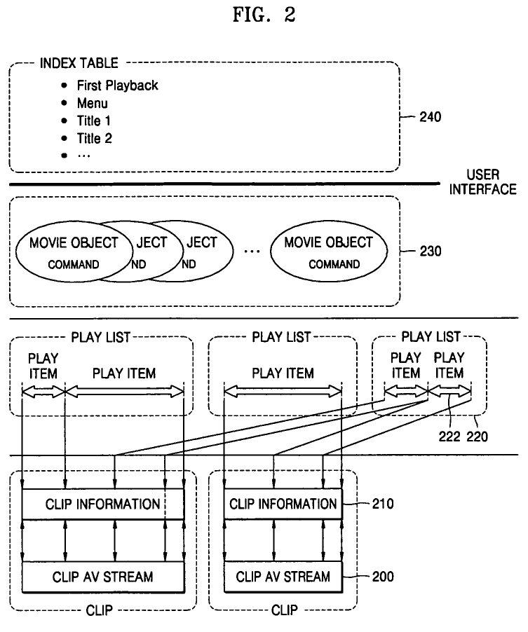

FIG. 2 illustrates a structure of multimedia data recorded on the information recording medium illustrated in FIG. 1. Referring to FIG. 2, the multimedia data recorded on the information recording medium 400 are formed of four layers. Each of the four layers includes clips 200 and 210 which together represent a recording unit of multimedia video, a play list 220 which represents a reproduction unit of the multimedia video, a movie object 230 that includes a navigation command language to reproduce the multimedia video, and an index table 240 that designates a movie object to be first reproduced and each title.

The clips 200 and 210 realize attributes of an AV data stream for a high quality movie and an AV data stream as one object. The AV data stream is called a clip AV stream 200, and the attribute information of the AV data stream is called clip information 210. The play list 220 is a collection of reproduction periods of the previously described clips 200 and 210. Each of the reproduction periods is called a play item 222. The movie object 230 is formed of navigation command language programs. Navigation command languages are used to start the reproduction of the play list 220 and manage conversions between movie objects or reproduction of the play list 220 according to a user's preference. The index table 240 which is the highest level table to define a plurality of titles and menus includes information on start positions of all titles and menus and, thus, reproduces a title or menu selected by a user operation such as a title search or a menu call. The index table 240 also includes information on a start position of a title or menu to be first reproduced which is automatically executed when the information recording medium 100 is inserted into a reproducing apparatus.

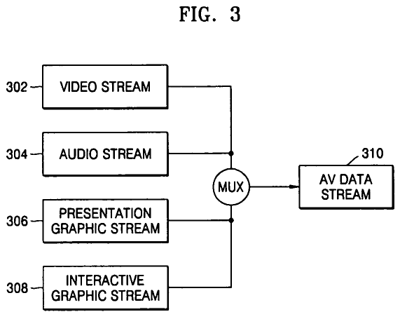

The structure of the clip AV stream 200 in which the multimedia video is compression-coded will now be described. FIG. 3 is a block diagram of the constitution of the clip AV stream illustrated in FIG. 2.

Referring to FIG. 3, an AV data stream 310 is recorded on the information recording medium 100, according to an embodiment of the present invention, in which a video stream 302, an audio stream 304, a presentation graphic stream 306 providing a sub title, and an interactive graphic stream 308 to provide a menu to interact with a user are multiplexed. The AV data stream 310 is called a main stream.

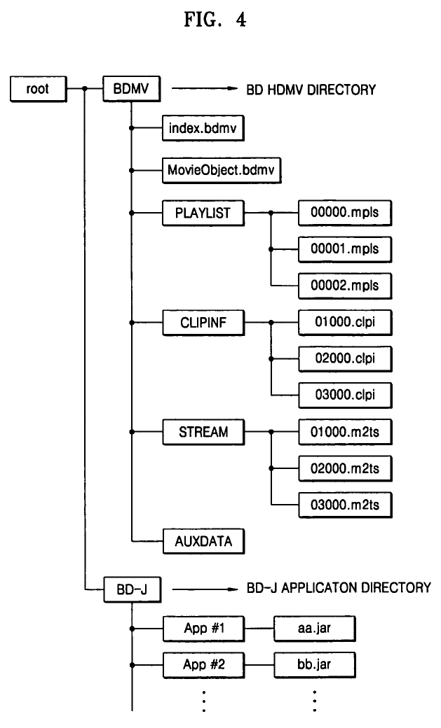

FIG. 4 illustrates a directory structure of the information recording medium on which the data illustrated in FIG. 1 are recorded.

Referring to FIGS. 2 and 4, the directory structure of files relating to multimedia data recorded on the information recording medium 100 according to an embodiment of the present invention is illustrated. A BDMV directory in which the high quality video data 110 are recorded under a root directory includes directories of the index table 240, the movie object 230, the play list 220, the clip information 210, the clip AV stream 200, and other data. A BD-J application directory in which the application data 120 for a programming operation are recorded under the root directory includes directories of application IDs and actual data of application programs.

In detail, the index table 240 is recorded in a file of index.bdmv, and the movie object 230, including navigation data, is recorded in a file of MovieObject.bdmv. The play list 220, which is a video reproduction unit, is recorded in a file of five numbers and an extension mpls under a PLAYLIST directory. The clip information 210 is recorded in a file of five numbers and an extension clpi under a CLIPINF directory. The clip AV stream 200 is recorded in a file of five numbers and an extension m2ts under a STREAM directory. In particular, a clip information file and its corresponding clip AV stream file have the same five numbers and a different extension. Other data such as a font file for a text sub title are recorded in an AUXDATA directory.

The application data 120 are recorded in a file of aa.jar under an APP # 1 directory that indicates IDs for identifying applications. The application data 120 store IDs of a plurality of applications and data in files of aa.jar, bb.jar, etc.

The above mentioned data may be downloaded; however, for descriptive convenience, the downloading of the play list 220, the clip AV stream 200, and the application data 120 only will now be described. An execution of a JAVA application for downloading included in the application data 120 results in a reproduction of the video data 110 which are recorded on the information recording medium 100 by downloading a file from an external database via a network. In this regard, an object file in the information recording medium 100 is replaced with a file that may be one of files that are obtained by downloading the clip AV stream 200, the play list 220, and other application data. Alternately, the object file in the information recording medium 100 may be replaced with a file that may be one of a single unit file that is obtained by downloading the clip AV stream 200, the play list 220, and other application data which is added to files in the information recording medium 100. The downloaded data are stored in local storage to be described later. To easily connect the downloaded data to files recorded on the information recording medium 100, the downloaded data having the same directory structure as the directory structure of the information recording medium 100 illustrated in FIG. 4 may be stored in local storage.

A forming of a new virtual file system using directory information recorded in the information recording medium 100 and directory information stored in local storage as illustrated in FIG. 4 will now be described.

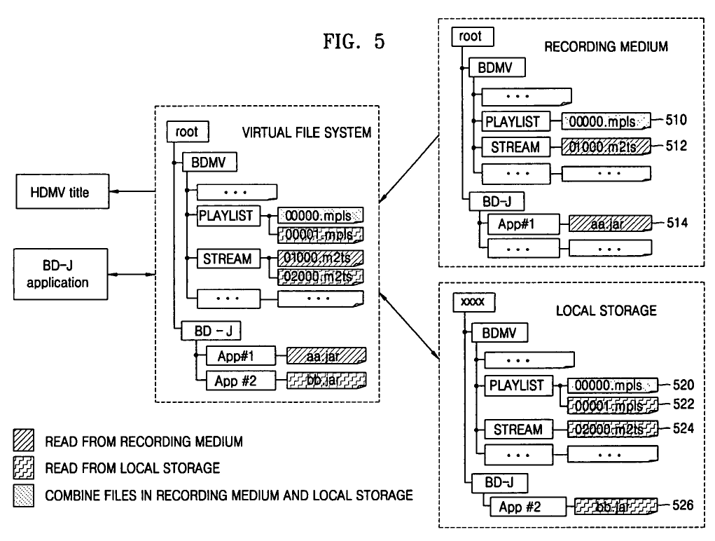

FIG. 5 illustrates the forming of the virtual file system according to an embodiment of the present invention. Referring to FIG. 5, to form the virtual file system, the directory information recorded in the information recording medium 100 and the directory information stored in local storage device are read. In this regard, the information recording medium 100 or the local storage device includes files having the same name, both the information recording medium 100 and the local storage include files having the same name, or files included in the information recording medium 100 and the local storage are combined into a file. Each case will now be described in detail.

First, data included in the virtual file system are based on data included in the information recording medium 100 or the local storage. 01000.m2ts 512 and aa.jar 514 are included in the information recording medium 100, whereas 00001.mpls 522, 02000.m2ts 524 and bb.jar 526 are included in the local storage. Therefore, the virtual file system stores the 01000.m2ts 512 and the 02000.m2ts 524 which do not have a redundant file name under the STREAM directory, the 00001.mpls 522 under the PLAYLIST directory, and the aa.jar 514 and the bb.jar 526 under the BD-J directory.

If a reproduction engine or a JAVA application for reproducing a HDMV title requests data included in the virtual file system, a reproducing apparatus verifies positions of actual data corresponding to the data in directories of the virtual file system and reads data from the information recording medium 100 or the local storage in which the actual data are stored.

Second, both the information recording medium 100 and the local storage device include files having the same name. In this case, the virtual file system provides data to an application or the navigation engine based on data recorded on the information recording medium 100 or data stored in the local storage according to a predetermined condition. That is, the virtual file system may be formed using a new version or a newly generated file based on a file version or a file generation date.

Third, both data stored in the information recording medium 100 and the local storage are used. That is, a play list 00000.mpls 510 recorded on the information recording medium 100 or a play list 00000.mpls 520 stored in the local storage are combined into a play list which is used to form the virtual file system. When a contents producer provides additional data to data recorded on the information recording medium 100, new data obtained by combining the data recorded on the information recording medium 100 with the additional data are not downloaded from a server but only the additional data are downloaded to combine with the data recorded on the information recording medium 100, so that the combined data are generated.

The virtual file system described above is used when video recorded on the information recording medium 100 includes only navigation data used to reproduce an English sub title and audio, a contents producer additionally produces a Korean sub title and audio for the video and provides the produced Korean sub title and audio with related navigation data through the server. A user downloads the Korean sub title, audio, and navigation data through a network and stores them in the local storage device. The reproducing apparatus uses one navigation file obtained by combining the related navigation data recorded on the information recording medium 100 and the downloaded navigation data so as to reproduce the Korean sub title, audio, and navigation data stored in the local storage device along with the video recorded on the information recording medium 100 using the virtual file system described above. Therefore, the presentation engine of the reproducing apparatus or the JAVA application using the presentation engine may reproduce video such as a single file including the directory information on the contents stored in both the information recording medium 100 and the local storage using the virtual file system.

After the forming of the virtual file system, the reproducing apparatus reproduces AV stream stored in the information recording medium 100 or the local storage device based on the virtual file system. As illustrated in FIG. 5, the virtual file system has the same file and directory structure as the information recording medium 100. The information recording medium 100, which is a read-only medium, cannot record data generated by executing an application, e.g., the JAVA application, whereas, the virtual file system includes a region in which data generated by the application are recorded.

An apparatus to reproduce video using the virtual file system according to an embodiment of the present invention will now be described in detail.

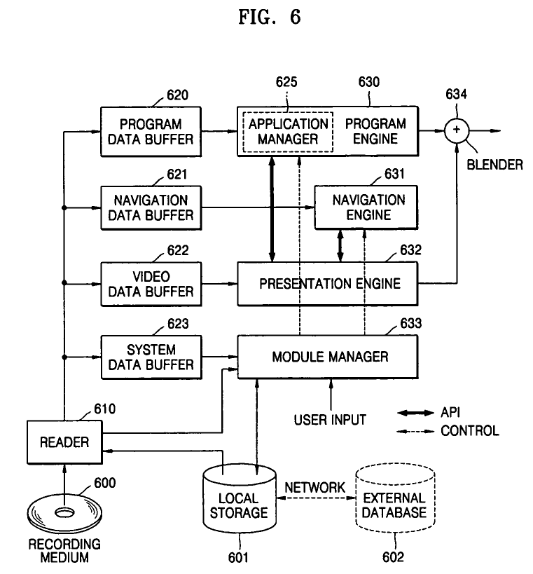

FIG. 6 is a block diagram of a reproducing apparatus according to an embodiment of the present invention. Referring to FIG. 6, the reproducing apparatus includes a reader 610 that reads data from an information recording medium 600, buffers 620 through 623 that each temporarily store the read data, and reproducers 625 through 634 that are engines to reproduce the buffered data. The reproducers 625 through 634 include a module manager 633 that controls a navigation engine to initially execute system data and process a title change caused by a user selection or a navigation change, etc., a navigation engine 631 that controls reproduction of video according to the content of navigation data, a presentation engine 632 that displays decoded video data on a screen, and a program engine 630 that executes an application program. A plurality of program engines may be used according to types of applications. For example, to reproduce a JAVA application and an HTML application together, a JAVA virtual machine to execute the JAVA application and a browser engine to execute the HTML application are required.

The reproducing apparatus further includes a blender 634 that forms one screen by overlaying an execution result of the application program executed by the program engine 630 and a reproduction result of video data displayed by the presentation engine 632 into a single image. The program engine 630 may preferably include an application manager 625 that controls execution of an application program using an application object to provide a programming function.

The reproducing apparatus includes local storage 601 that stores a program application downloaded from the information recording medium 600 or an external database 602. Therefore, the module manager 633 forms the virtual file system as described with reference to FIG. 5 using data read from the information recording medium 600 and the local storage 601 and provides reproduction control information to the program engine 630 and the navigation engine 631.

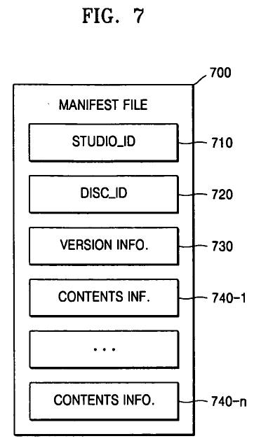

FIG. 7 illustrates a structure of a manifest file. Referring to FIG. 7, the manifest file 700 includes information on contents stored in the local storage of the reproducing apparatus. In detail, the manifest file 700, which is meta data used to reproduce new contents stored in the local storage device and contents recorded on the information recording medium together, is not included in the initial information recording medium but is downloaded with the new contents through a network for binding of the downloaded contents and convenience of deletion and is stored in the local storage device or a specific storage.

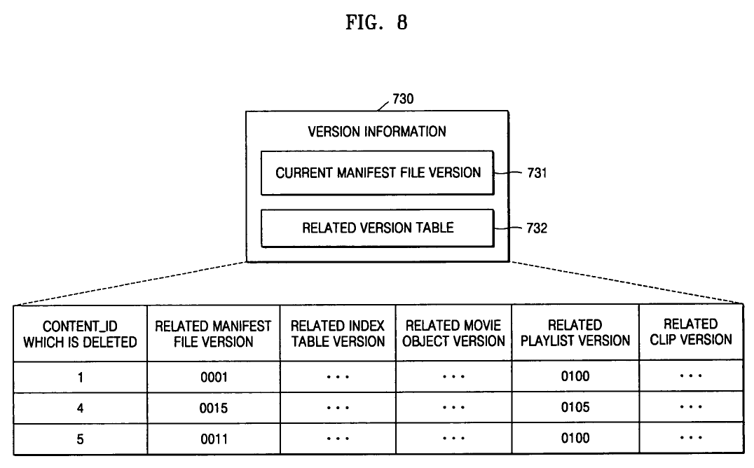

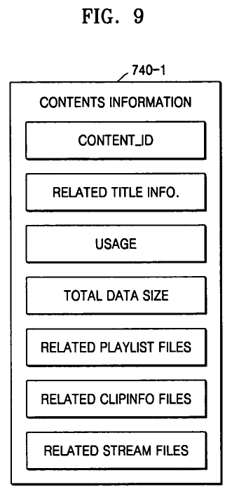

The manifest file 700 includes a studio ID studio_id 710 that represents information on producers that produce movie titles recorded on discs, a disc ID disc_id 720 that identifies discs, version information version_info 730 of manifest information, and a plurality of contents information content_info 740-1 through 740-n that represent description information on contents recorded on discs. In detail, the studio ID studio_id 710 includes information on contents producers such as Sony Pictures, Walt Disney Company, 20^{th} Century Fox Company, etc. The disc ID disc_id 720 includes numbers to identify each disc. The version information version_info 730 and the contents information content_info 740-1 through 740-n will now be described in detail with reference to FIGS. 8 and 9.

FIG. 8 illustrates a constitution of the version information 730 included in the manifest file illustrated in FIG. 7. Referring to FIG. 8, the version information 730 includes a current manifest file version 731 and a related version table 732. The related version table 732, in detail, includes a contents ID which is deleted, a related manifest file version, a related index table version, a related movie object version, a related play list version, and a related clip version.

With regard to the use of the related version table 732, in a case where values 1, 4, and 5 of contents IDs, which are deleted, correspond to a Korean sub title, an English sub title, and a Japanese sub title, respectively, if a user deletes the contents ID value 5 corresponding to the Japanese sub title, a manifest file having version information 0011 and a related play list having version information 0100 are downloaded from a server database again.

FIG. 9 illustrates a constitution of the contents information 740-1 through 740-n included in the manifest file illustrated in FIG. 7. Referring to FIG. 9, the contents information 740-1 through 740-n includes a contents ID, related title information, usage, a total data size, related play list files, related clip information files, and related stream files.

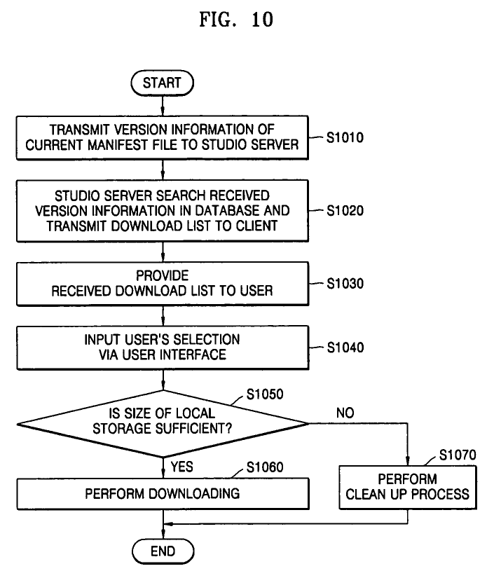

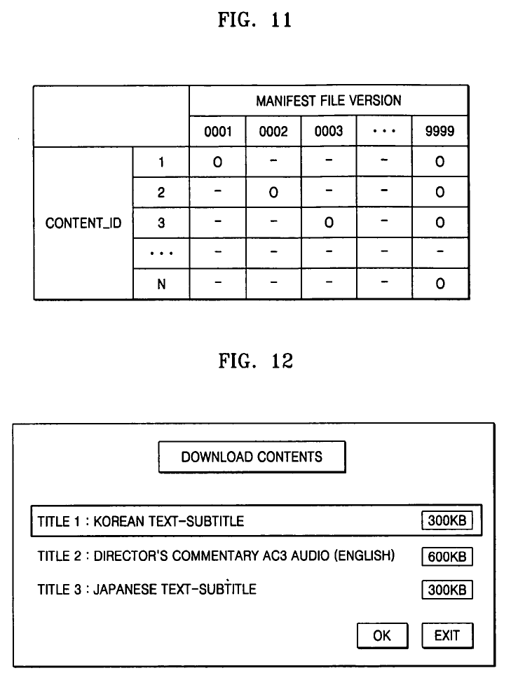

FIG. 10 is a flowchart of a method of downloading contents according to an embodiment of the present invention. Referring to FIG. 10, a client transmits version information of a current manifest file to a studio server (Operation 1010). The studio server searches for the database included therein, makes a download list based on the received version information, and transmits the download list to the client (Operation 1020). The database includes information on contents to be downloaded according to the version information. The information will now be described with reference to FIG. 11.

FIG. 11 exemplarily illustrates information on relationship between contents recorded on the database included in the studio server and the manifest file. Referring to FIG. 11, if a version value of a received manifest file is 0002, since contents having a contents ID 2 are stored in a local memory of the client, contents having contents IDs other than the contents ID 2 may be downloaded. Such facts may be relayed to a user via a screen (Operation 1030).

FIG. 12 exemplarily illustrates a screen provided to download contents. Referring to FIG. 12, the screen provides a user who has a disc having an English sub title with information on names and sizes of contents related to the disc to be downloaded from a studio server by analyzing a table corresponding to the manifest file stored in the current local memory as illustrated in FIG. 11.

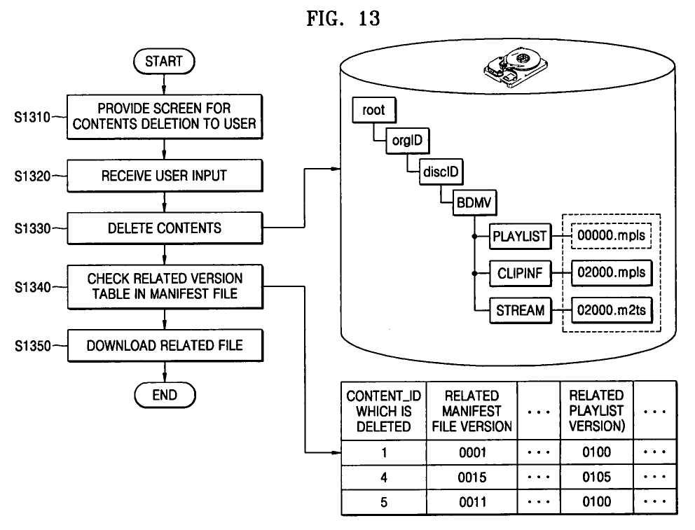

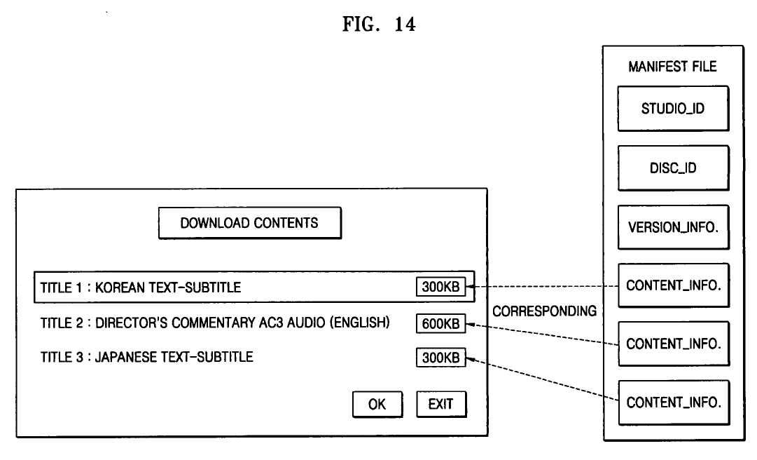

If the user selects a title in the screen, a user input is received from a user interface (Operation 1040). The user determines whether the size of the local memory is enough to download the selected contents (Operation 1050), downloads the selected contents if the size of the local memory is determined to be sufficient to download the selected contents, (Operation 1060), and performs a clean up process that deletes contents stored in the local memory if the size of the local memory is determined to not be sufficient to download the selected contents, (Operation 1070). The clean up process will now be described with reference to FIGS. 13 and 14.

FIG. 13 is a flowchart of the clean up process according to an embodiment of the present invention. Referring to FIG. 13, a screen for deleting contents is provided to a user (Operation 1310). The screen is illustrated in FIG. 14. If the user selects contents to be deleted in the screen, the user's input is received (Operation 1320). The contents are deleted (Operation 1330). A related version table is checked in the manifest file (Operation 1340), and a related file is downloaded (Operation 1350).

FIG. 14 exemplarily illustrates the screen provided to delete contents. Referring to FIG. 14, the user selects one contents among contents stored in the current local memory and deletes the selected contents. A program used to delete contents is a JAVA program, which may be stored as program data or realized as a resident program of the client.

According to the present invention as is described above, it is relatively easy to reproduce new contents obtained by combining contents recorded on an information recording medium with contents downloaded via a network, additionally download contents, and delete contents.

The present invention may also be embodied as computer readable code on a computer readable recording medium. The computer readable recording medium is any data storage device that may store data which may be thereafter read by a computer system. Examples of the computer readable recording medium include read-only memory (ROM), random-access memory (RAM), CD-ROMs, magnetic tapes, floppy disks, optical data storage devices, and carrier waves.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A structure of a manifest file including contents information, wherein the manifest file comprises version information of the manifest file and description information on at least one predetermined unit forming the contents.

2. The structure of claim 1, wherein the manifest file further comprises:
a studio ID that represents information on producers that produce the contents;
a disc ID to identify information recording media storing the contents; and
at least a piece of contents information that represents description information in a predetermined unit that divides the contents recorded on the information recording media.

3. The structure of claim 2, wherein the version information comprises:
a version value of a current manifest file; and
a table regarding the predetermined unit relating to a deletion of contents.

4. The structure of any one of claims 1 through 3, wherein the predetermined unit is a play list that represents a reproduction unit forming the contents.

5. The structure of claim 3, wherein the table comprises a contents ID which is deleted, a related manifest file version, a related index table version, a related movie object version, a related play list version, and a related clip version.

6. The structure of claim 2, wherein the contents information comprises a contents ID, related title information, usage of the contents, a total data size, related play list files, related clip information files, and related stream files.

7. A method of downloading contents from an apparatus to reproduce the contents using a local storage, the method comprising:
receiving a contents download list prepared based on version information of a manifest file including information on contents stored in the local storage; and
selecting contents to be downloaded in the received contents download list, downloading the selected contents if a size of a local memory of the local storage is to determined to be sufficient to download the selected contents, and deleting a part of contents in the local storage device and downloading the selected contents if the size of the local memory is determined to not be sufficient to download the selected contents.

8. The method of claim 7, wherein the manifest file comprises version information of the manifest file and description information on at least one predetermined unit forming the contents.

9. The method of claim 7, wherein the manifest file comprises:
a studio ID that represents information on producers that produce the contents;
a disc ID to identify information recording media storing the contents; and
at least a piece of contents information that represents description information in a predetermined unit that divides the contents recorded on the information recording media.

10. The method of claim 7, further comprising downloading the selected contents based on a related version table included in the manifest file after deleting contents that are selected to be deleted by a user after the deletion of a part of the contents in the local storage device.

11. The method of claim 7, wherein a program used to delete contents after the deletion of a part of the local storage is a JAVA program stored as program data or realized as a resident program in a replacement apparatus.

12. The method according to claim 7, further comprising forming a virtual file system by reading directory information recorded in an information recording medium and the local storage.

13. The method according to claim 12, wherein, where data included in the virtual file system are based on data included in the information recording medium or the local storage such that the directory information is different for each, the virtual file system stores the files under a STREAM directory, a PLAYLIST directory, and/or a BD-J directory.

14. The method according to claim 12, wherein, where both the information recording medium and the local storage device include files having the same name, the virtual file system provides data to an application or a navigation engine based on data recorded on the information recording medium or data stored in the local storage.

15. The method according to claim 12, wherein, where both data stored in the information recording medium and the local storage are used, files recorded on the information recording medium or in the local storage are combined into a play list which is used to form the virtual file system.

16. The method according to claim 12, further comprising reproducing a single file including the directory information on the contents stored in both the information recording medium and the local storage using the virtual file system.

17. An apparatus to reproduce contents obtained by combining contents stored in a local storage device to store downloaded contents and/or contents read from a recording medium, the apparatus comprising:
an application manager to receive a contents download list prepared based on version information of a manifest file including information on contents stored in the local storage device, selecting contents to be downloaded in the received download list, to download the selected contents if a size of the local memory is determined to be sufficient to download the selected contents, and to delete a part of contents in the local storage device and downloading the selected contents if the size of the local memory is determined to not be sufficient.

18. The apparatus of claim 17, wherein the manifest file comprises:
a studio ID that represents information on producers that produce the contents;
a disc ID to identify information recording media storing the contents; and
at least a piece of contents information that represents description information in a predetermined unit that divides the contents recorded on the information recording media.

19. A computer readable recording medium having recorded thereon a program for executing the method of claim 5.

20. A computer readable recording medium having recorded thereon a program for executing the method of claim 6.

21. A computer readable recording medium having recorded thereon a program for executing the method of claim 7.

22. A computer readable recording medium having recorded thereon a program for executing the method of claim 8.

23. An application manager of an apparatus to reproduce contents obtained by combining contents stored in a local storage device to store downloaded contents and/or contents read from a recording medium to receive a contents download list based on version information of a manifest file including information on contents stored in the local storage device, to select contents to be downloaded in the received download list, to download the selected contents if a size of the local memory is determined to be sufficient to download the selected contents, and to delete a part of contents in the local storage device and download the selected contents if the size of the local memory is determined to not be sufficient, wherein the manifest file comprises:
a studio ID that represents information on producers that produce the contents;
a disc ID to identify information recording media storing the contents; and
at least a piece of contents information that represents description information in a predetermined unit that divides the contents recorded on the information recording media.
